(19) United States
(12) Patent Application Publication
(10) Pub. No.: US 2014/0077506 A1
(43) Pub. Date: Mar. 20, 2014

(54) MODULAR CONFIGURATION FOR AN LP TOWABLE GENSET

(71) Applicants: Curtis D. Knight, Milwaukee, WI (US); Todd Matte, Howards Grove, WI (US); Aaron Kuhlow, Howards Grove, WI (US)

(72) Inventors: Curtis D. Knight, Milwaukee, WI (US); Todd Matte, Howards Grove, WI (US); Aaron Kuhlow, Howards Grove, WI (US)

(73) Assignee: Kohler Co., Kohler, WI (US)

(21) Appl. No.: 13/616,590

(22) Filed: Sep. 14, 2012

(51) Int. Cl. H02K 7/18

(52) U.S. Cl. 290/1 A

(57) ABSTRACT

Some embodiments relate to an example towable power generation system. The towable power generation system includes an internal combustion engine and an alternator driven by the internal combustion engine to generate electrical power. The towable power generation system further includes a skid such that the internal combustion engine and alternator are mounted on the skid. The towable power generation system further includes a structural frame that includes at least one gaseous fuel source for supplying fuel to the internal combustion engine. The skid is configured to be mounted onto the structural frame and/or a movable vehicle. The skid is also configured to be mounted on the ground. The structural frame is adapted to be mounted onto the movable vehicle. The structural frame is also adapted to be mounted on the ground.

### TECHNICAL FIELD

Embodiments pertain to a LP towable genset, and more particularly to a modular configuration for a LP towable genset with an onboard fuel supply.

### BACKGROUND

Existing portable power generation systems are typically used to provide temporary power at remote locations. As examples, such portable power generation systems may be used to provide power at construction sites, emergency response sites or other locations that do not have ready access to utility power.

Some portable power generation systems are large enough that they need to be mounted to a flat bed truck or a trailer in order to move the portable power generation system from/to a remote location. When such portable power generation systems include a trailer, the trailer typically includes one or more axles, wheels, a frame and a tongue for attaching the trailer to a towing vehicle.

Conventional portable power generation systems include some form of electric generator. One common type of electric generator includes an internal combustion engine that drives an electrical alternator to produce alternating electricity.

One of the drawbacks with existing portable power generation systems is that such systems commonly utilize diesel fuel. The use of diesel fuel is undesirable because Tier IV emissions requirements have increased the cost per kilowatt associated with producing portable power.

In addition, the use of diesel fuel diesel usually generates an unsatisfactory amount of emission particulates into the environment where the portable generator system is located. It should be noted that diesel fuel costs per gallon continues to rise thereby increasing the cost per kilowatt associated with producing portable power.

Therefore, a need exists for a portable power generation system that avoids the use of diesel fuel yet still provides sufficient generator run time in a relatively cost effective manner. The portable power generation system should also be able to reduce the amount of emission particulates that are ejected into the environment where the portable generator system is located.

### BRIEF DESCRIPTION OF THE DRAWINGS

FIG. 1 is a side view illustrating an example towable power generation system.

FIG. 2 is a partial side section view of the example towable power generation system shown in FIG. 1.

FIG. 3 is a partial perspective section view of the example towable power generation system shown in FIG. 1.

FIG. 4 is a side view similar to FIG. 1 where the frame that includes a gaseous fuel source is not included in the example towable power generation system and a skid that supports the genset is mounted directly to the trailer.

FIG. 5 is a side view similar to FIG. 1 where the frame that includes the gaseous fuel source and a skid that supports a genset are removed from the trailer and located on the ground.

FIG. 6 is a side view similar to FIG. 1 where a skid that supports the genset is removed from the trailer and located on the ground.

FIG. 7 is a side view similar to FIG. 1 where the frame that includes a gaseous fuel source is removed from the trailer and located on the ground.

FIG. 8 is a schematic top section view of the frame that includes a gaseous fuel source taken along line 8-8 in FIG. 7.

FIG. 9 is a schematic side section view of the frame that includes a gaseous fuel source taken along line 9-9 in FIG. 8.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

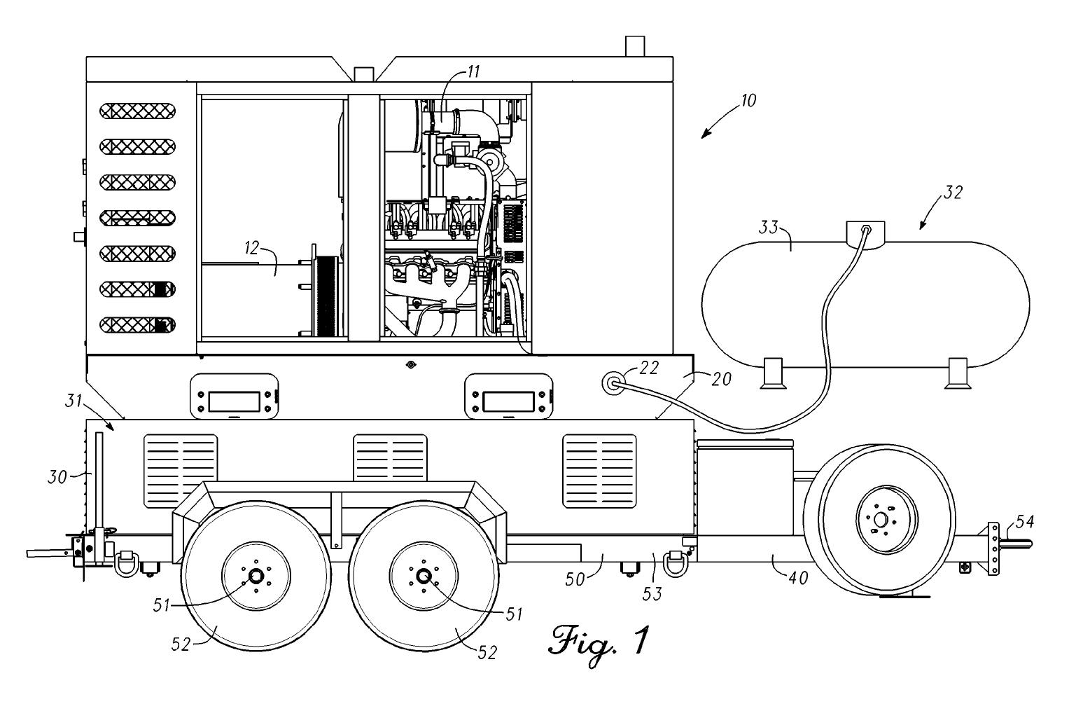

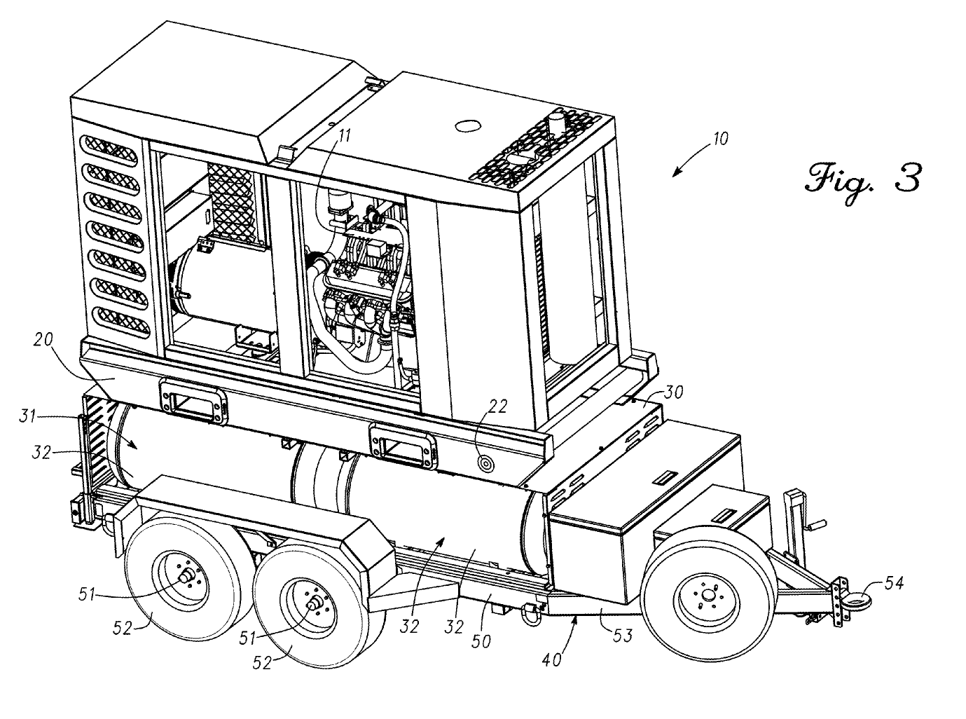

FIGS. 1-3 illustrate an example towable power generation system 10. The towable power generation system 10 includes an internal combustion engine 11 and an alternator 12 driven by the internal combustion engine 11 to generate electrical power. The towable power generation system 10 further includes a skid 20 such that the internal combustion engine 11 and alternator 12 are mounted on the skid 20.

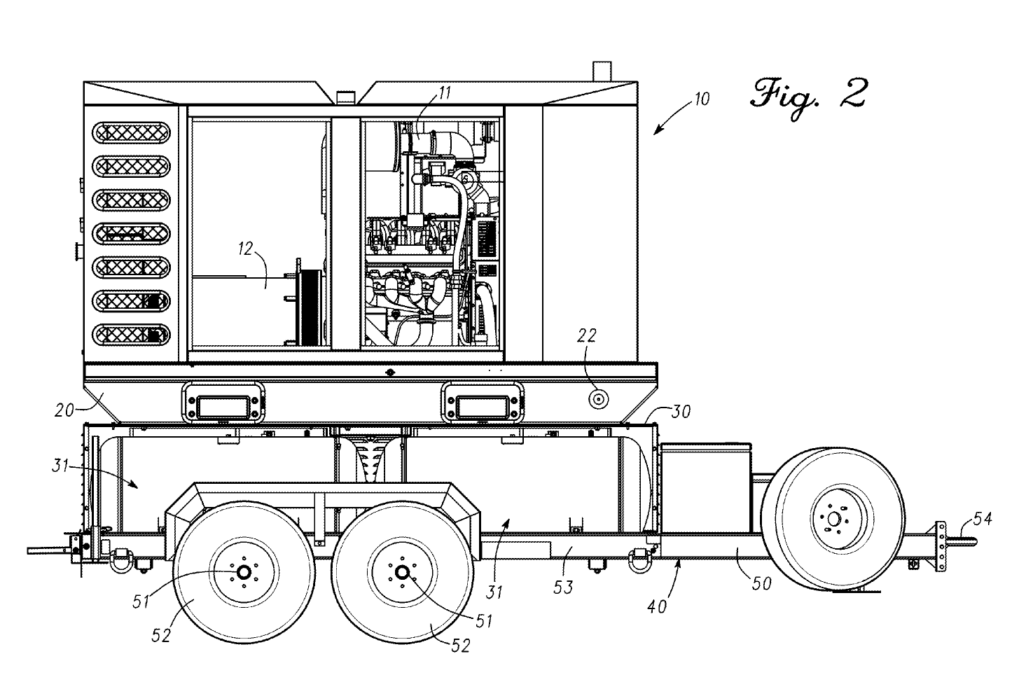

The towable power generation system 10 further includes a structural frame 30 that includes at least one gaseous fuel source 31 (see FIGS. 2, 3, 8 and 9) for supplying fuel to the internal combustion engine 11. Using a gaseous fuel source 31 to supply fuel to the internal combustion engine 11 may avoid the undesirable use of diesel fuel yet still provide sufficient generator run time in a relatively cost effective manner. In addition, using a gaseous fuel source 31 to supply fuel to the internal combustion engine 11 may reduce the amount of emission particulates that are ejected into the environment where the towable generator system 10 is located.

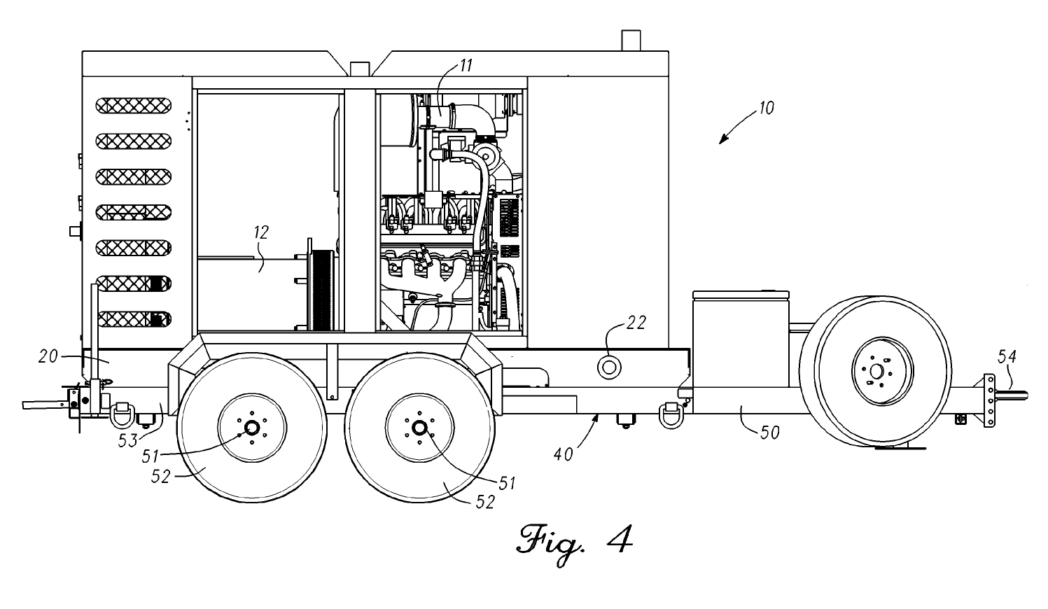

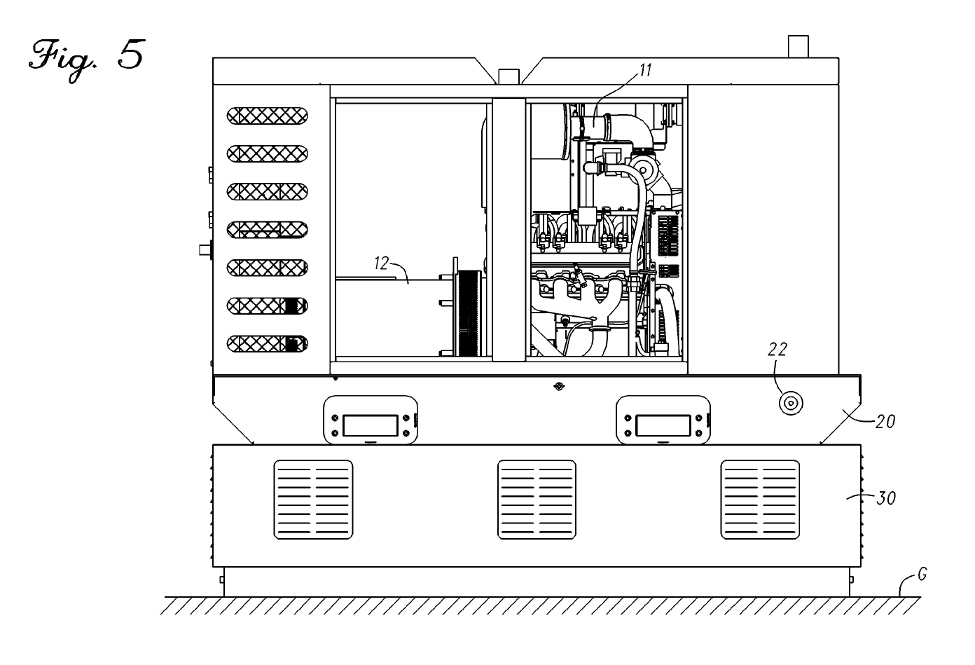

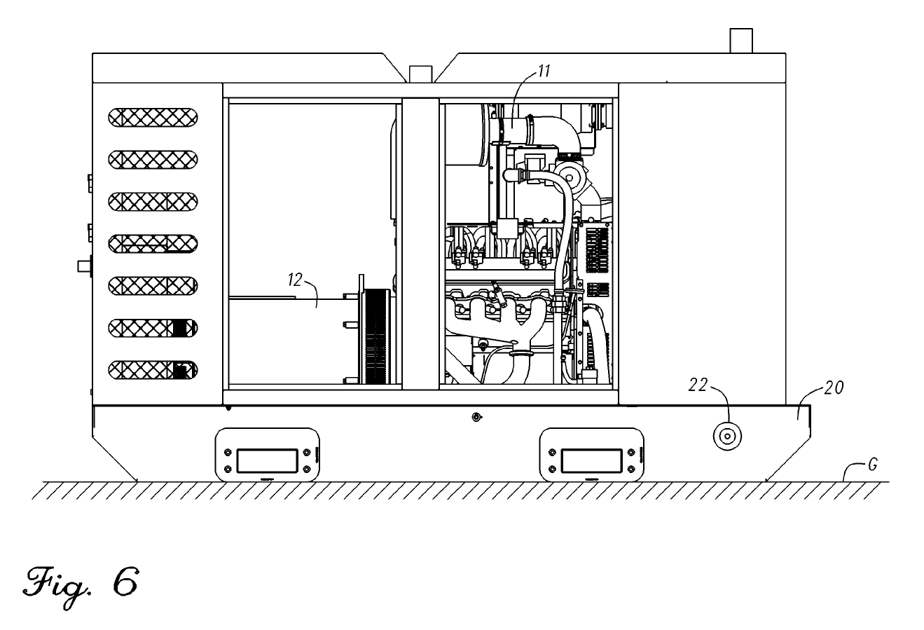

The skid 20 is configured to be mounted onto the structural frame 30 (see FIGS. 1-3 and 5) and/or a movable vehicle 40 (see FIG. 4). The skid 20 is also configured to be mounted on the ground G (see FIG. 6).

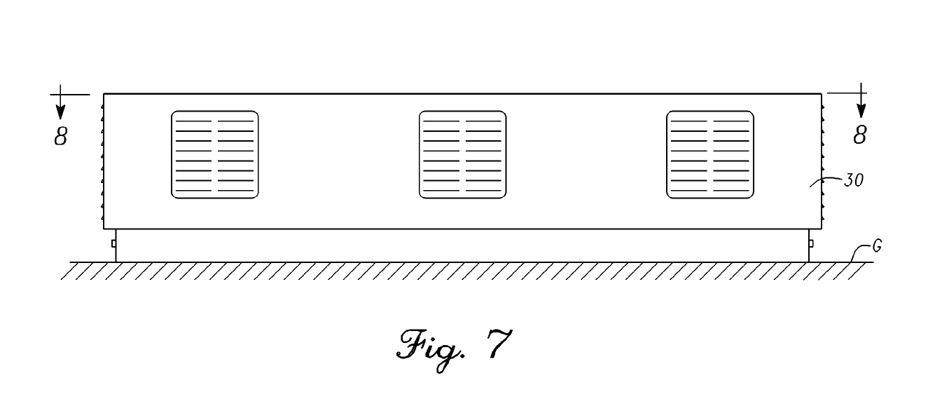

The structural frame 30 is adapted to be mounted onto the movable vehicle 40 (see FIGS. 1-3 and 5). The structural frame 30 is also adapted to be mounted on the ground G (see FIG. 7).

The ability to mount the skid 20 to the frame 30, the movable vehicle 40 or the ground G may provide an enhanced flexibility in the usage, storage and transportation of the towable power generation system 10. In addition, the ability to mount the structural frame 30 to either the movable vehicle 40 or ground G may further provide an enhanced flexibility in the usage, storage and transportation of the towable power generation system 10.

In the illustrated example embodiments, the movable vehicle 40 is a trailer 50 that is configured to be towed by another vehicle (not shown). The trailer includes one or more axles 51, wheels 52, a frame 53 and a tongue 54 for attaching the trailer 50 to a towing vehicle. In other embodiments, the movable vehicle 40 is a flat bed truck (not shown).

In the example embodiment that is illustrated in FIG. 1, the towable power generation system 10 further includes an additional gaseous fuel source 32 that supplies fuel to the internal combustion engine 11. In some embodiments, the additional gaseous fuel source 32 is connected to a port 22 on the skid 20 such that the additional gaseous fuel source 32 supplies fuel to the internal combustion engine 11 through the port 22. The size, type and location of the port 22 that is included as part of the skid 20 may vary depending on the type of towable power generation system 10 (among other factors).

In the example embodiment that is illustrated in FIG. 1, the additional gaseous fuel source 32 includes a tank 33 filled with a gaseous fuel. The size, type and location of the tank 33 may vary depending on the desired run time of towable power generation system 10 (among other factors).

Embodiments are also contemplated wherein the additional gaseous fuel source 32 includes an infrastructure gaseous fuel supply line (not shown). As an example, the internal combustion engine 11 may be connected into a hardwired gaseous fuel supply line that provides gaseous fuel to a dwelling (e.g., natural gas that is supplied to a business or residence).

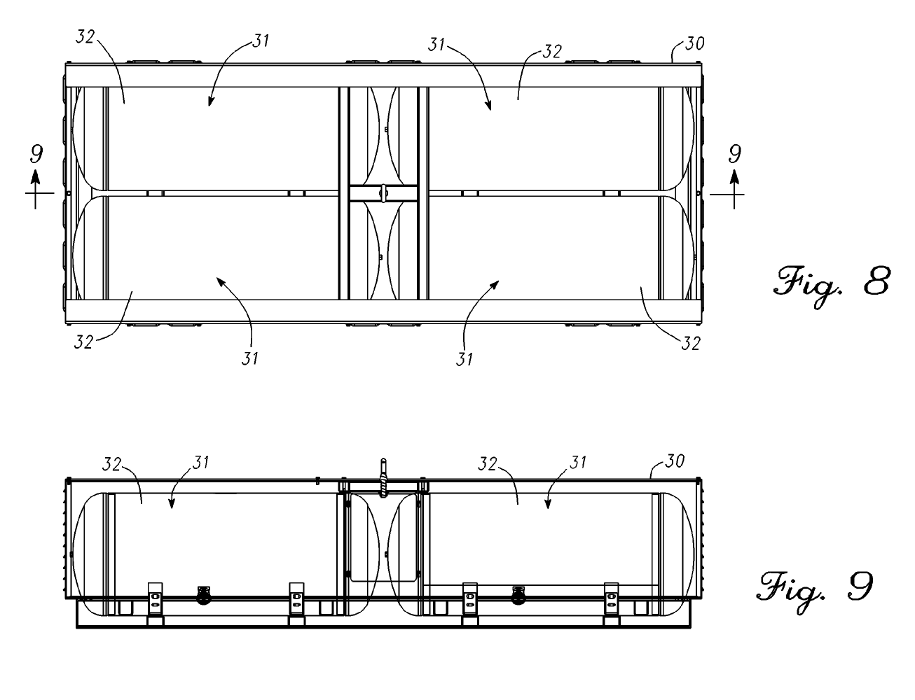

As shown in FIGS. 2, 3, 8 and 9, the at least one gaseous fuel source 31 that is included in the structural frame 30 may include a plurality of tanks 32 that are each filled with a gaseous fuel and capable of supplying the fuel to the internal combustion engine 11. In the example embodiment that is illustrated in FIG. 8, the plurality of tanks 32 that are each filled with a gaseous fuel includes four tanks 32. It should be noted that the tanks 32 may be designed to (i) simultaneously supply fuel to the internal combustion engine 11; or (ii) sequentially supply fuel to the internal combustion engine 11.

The size, type, number and location of the tanks 32 that are included in the structural frame 30 may vary depending on the desired run time of towable power generation system 10 and the overall design of the structural frame 30 (among other factors). FIG. 8 shows an example embodiment where the four tanks 32 are arranged in a two by two formation within the structural frame 30.

The towable power generation systems 10 described herein may provide a portable power generation system that avoids the use of diesel fuel yet still provides sufficient generator run time in a relatively cost effective manner. The towable power generation systems 10 may also be able to reduce the amount of emission particulates that are ejected into the environment where the towable generator system 10 is located. In addition, the modular configuration of the skid 20, frame 30 and movable vehicle 40 may provide an enhanced flexibility in the usage, storage and transportation of the towable power generation system 10.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A towable power generation system comprising:
an internal combustion engine;
an alternator driven by the internal combustion engine to generate electrical power;
a skid such that the internal combustion engine and alternator are mounted on the skid;
a structural frame that includes at least one gaseous fuel source for supplying fuel to the internal combustion engine; and
wherein the skid is configured to be mounted onto the structural frame, and wherein the skid is configured to be mounted onto a movable vehicle, and wherein the skid is configured to be mounted on the ground, and wherein the structural frame is adapted to be mounted onto the movable vehicle, and wherein the structural frame is adapted to be mounted on the ground.

2. The towable power generation system of claim 1, wherein the movable vehicle is a flat bed truck.

3. The towable power generation system of claim 1, wherein the movable vehicle is a trailer configured to be towed by another vehicle.

4. The towable power generation system of claim 1, wherein the skid includes a port for connection to an additional gaseous fuel source that supplies fuel to the internal combustion engine.

5. The towable power generation system of claim 1, further comprising an additional gaseous fuel source that supplies fuel to the internal combustion engine.

6. The towable power generation system of claim 5, wherein the additional gaseous fuel source is connected to a port on the skid such that the additional gaseous fuel source supplies fuel to the internal combustion engine through the port.

7. The towable power generation system of claim 5, wherein the additional gaseous fuel source includes a tank filled with a gaseous fuel.

8. The towable power generation system of claim 5, wherein the additional gaseous fuel source includes an infrastructure gaseous fuel supply line.

9. The towable power generation system of claim 1, wherein the at least one gaseous fuel source that is included in the structural frame includes a plurality of tanks that are each filled with a gaseous fuel.

10. The towable power generation system of claim 9, wherein the plurality of tanks that are each filled with a gaseous fuel includes four tanks.

11. The towable power generation system of claim 10, wherein the four tanks are arranged in a two by two formation.

12. A power generation system comprising:
an internal combustion engine;
an alternator driven by the internal combustion engine to generate electrical power;
a skid such that the internal combustion engine and alternator are mounted on the skid;
a structural frame that includes at least one gaseous fuel source for supplying fuel to the internal combustion engine;
a trailer configured to be attached to a vehicle that is adapted to tow the trailer; and
wherein the skid is configured to be mounted onto the structural frame, and wherein the skid is configured to be mounted onto the trailer, and wherein the skid is configured to be mounted on the ground, and wherein the structural frame is adapted to be mounted onto the trailer, and wherein the structural frame is adapted to be mounted on the ground.

13. The towable power generation system of claim 12, wherein the skid includes a port for connection to an additional gaseous fuel source that supplies fuel to the internal combustion engine.

14. The towable power generation system of claim 12, further comprising an additional gaseous fuel source that supplies fuel to the internal combustion engine.

15. The towable power generation system of claim 14, wherein the additional gaseous fuel source is connected to a port on the skid such that the additional gaseous fuel source supplies fuel to the internal combustion engine through the port.

16. The towable power generation system of claim 14, wherein the additional gaseous fuel source includes a tank filled with a gaseous fuel.

17. The towable power generation system of claim 14, wherein the additional gaseous fuel source includes an infrastructure gaseous fuel supply line.

18. The towable power generation system of claim 12, wherein the at least one gaseous fuel source includes a plurality of tanks that are each filled with a gaseous fuel.

19. The towable power generation system of claim 12, wherein the trailer includes at least one axle, at least one pair of wheels, a frame and a tongue adapted to attach the trailer to a moving vehicle.
